(19) United States
(12) Patent Application Publication
(10) Pub. No.: US 2011/0068249 A1
(43) Pub. Date: Mar. 24, 2011

(54) Mold and Method for Manufacturing the Same

(75) Inventors: Kun-Chih Pan, Hsin-Chu (TW); Chao-Hung Tseng, Hsin-Chu (TW); Chih-Hung CHU, Hsin-Chu (TW); Chia-Hsu Tu, Hsin-Chu (TW); Jen-Shun Lin, Hsin-Chu (TW)

(73) Assignee: AU OPTRONICS CORPORATION, Hsin-Chu (TW)

(21) Appl. No.: 12/955,502

(22) Filed: Nov. 29, 2010

Related U.S. Application Data
(62) Division of application No. 12/577,307, filed on Oct. 12, 2009.

(30) Foreign Application Priority Data
Nov. 14, 2008 (TW) 97144197

(51) Int. Cl. B28B 7/36

(52) U.S. Cl. 249/114.1

(57) ABSTRACT

A mold includes a substrate and a plurality of micro-structures. The micro-structures are disposed on the substrate. Each of the micro-structures includes a supporting layer and a convex top portion. The supporting layer is disposed on the substrate, wherein the material of the supporting layer is amorphous metal. The convex top portion is disposed on the supporting layer, wherein the material of the convex top portion is a thermoplastic polymer.

### RELATED APPLICATIONS

The present application is a divisional of U.S. application Ser. No. 12/577,307, filed on Oct. 12, 2009, which was based on, and claims priority from, Taiwan Application Ser. No. 97144197, filed Nov. 14, 2008, which is herein incorporated by reference.

### BACKGROUND OF THE INVENTION

1. Technical Field

The present disclosure relates to a mold, more particularly, to a mold for manufacturing optical elements.

2. Description of Related Art

Recently, liquid crystal displays are developed by electro-optical engineers due to market demands of the digital age. Liquid crystal displays have many advantages, such as high definition, small volume, lightweight, low voltage drive, low consumption of power, a broad range of applications, etc. Therefore, liquid crystal displays are already broadly used in consumer electronic devices or computer products, such as portable televisions, cellular phones, camcorders, laptop computers, desktop displays, projection televisions, etc., thereby becoming the main stream for displays.

“Backlight module” is one of the critical parts of a liquid crystal display. Generally, a backlight module is needed to make the screen and the information become visible to the user because liquid crystals cannot self-illuminate. Furthermore, some optical elements, e.g. a light guide plate, light diffusion films, and/or brightness enhancement films, may be built in the backlight module to enhance the brightness or the uniformity of the illumination.

Commercial optical films with a single type of optical features are manufactured by molding. However, optical films with a single type of optical features can no longer satisfy the market demands. Accordingly, a new mold is needed to solve this problem.

### SUMMARY OF THE INVENTION

According to one embodiment of the present invention, a method for manufacturing a mold includes the following steps. A substrate is provided, wherein the substrate has a supporting layer disposed thereon. A thermoplastic polymer layer is formed on the supporting layer. Both the thermoplastic polymer layer and the supporting layer are machined to form a plurality of micro-structures on the substrate. The machined thermoplastic polymer layer on the top of the micro-structures is reflowed.

According to another embodiment of the present invention, a mold includes a substrate and a plurality of micro-structures. The micro-structures are disposed on the substrate. Each of the micro-structures includes a supporting layer and a convex top portion. The supporting layer is disposed on the substrate, wherein the material of the supporting layer is amorphous metal. The convex top portion is disposed on the supporting layer, wherein the material of the convex top portion is a thermoplastic polymer.

### BRIEF DESCRIPTION OF THE DRAWINGS

FIGS. 1-6 are cross-sectional views depicting a method for manufacturing a mold according to one embodiment of the present invention;

FIG. 7 is a three-dimensional view of the mold of FIG. 4;

FIG. 8 is a three-dimensional view of a mold according to another embodiment of the present invention; and

FIG. 9 is a cross-sectional view of a mold according to yet another embodiment of the present invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

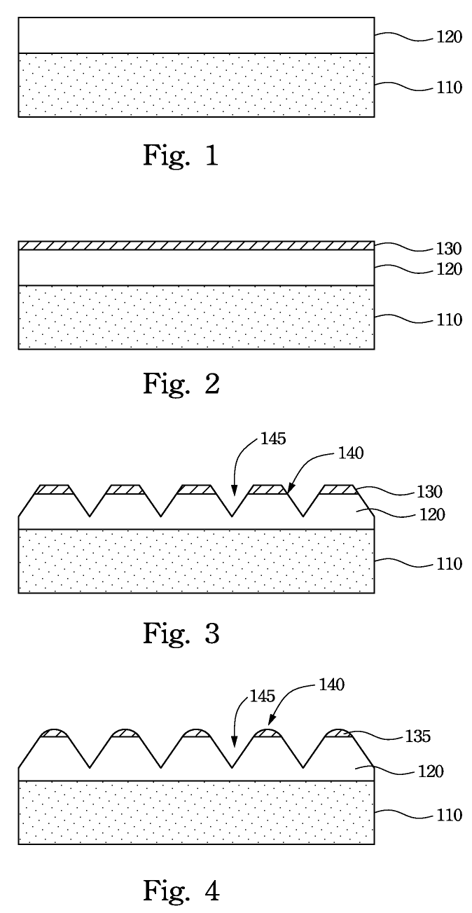

FIGS. 1-6 are cross-sectional views depicting a method for manufacturing a mold according to one embodiment of the present invention. The following steps are not recited in the sequence in which the steps are performed. That is, unless the sequence of the steps is expressly indicated, the sequence of the steps is interchangeable, and all or part of the steps may be simultaneously, partially simultaneously, or sequentially performed.

Reference is made to FIG. 1. A substrate 110 is provided, wherein the substrate 110 has a supporting layer 120 disposed thereon. In the present embodiment, the material of the supporting layer 120 is amorphous metal, e.g. an alloy of nickel and phosphorus containing about 9-13% of phosphorus by weight. It is appreciated that the alloy of nickel and phosphorus is only one of the examples, and the supporting layer 120 may be made of other amorphous metals.

The terms “about” as used herein may be applied to modify any quantitative representation which could permissibly vary without resulting in a change in the basic function to which it is related. For example, the alloy of nickel and phosphorus as disclosed herein containing about 9-13% of phosphorus by weight may permissibly contain less than 9% of phosphorus by weight or greater than 13% of phosphorus by weight within the scope of the invention if its amorphous structure is not materially altered.

Reference is made to FIG. 2. A thermoplastic polymer layer 130 is formed on the supporting layer 120. The material of the thermoplastic polymer layer 130 is a positive photoresist or polymethylmethacrylate (PMMA), and the thickness of the thermoplastic polymer layer 130 is about 0.1-500 μm. It is appreciated that the above-mentioned thermoplastic polymer layer 130 is only one of the examples, and the thermoplastic polymer layer 130 may be made of other material or have other thickness.

Reference is made to FIG. 3. Both the thermoplastic polymer layer 130 and the supporting layer 120 are machined to form a plurality of micro-structures 140 on the substrate 110. Specifically, the manufacturers may use a cutting tool to mechanically cut both the thermoplastic polymer layer 130 and the supporting layer 120 to form a plurality of grooves 145 therein. The grooves 145 can define the micro-structures 140, while an exposure process and a development process are not needed in this step.

Reference is made to FIG. 4. The machined thermoplastic polymer layer 130 on the top of the micro-structures 140 is reflowed, and then a surface of the reflowed thermoplastic polymer layer 135 is formed into a smooth shape due to surface tension, such as a convex shape or a spherical segment. Another machining is not needed in this step. Specifically, the reflowing step includes the following steps. First, the machined thermoplastic polymer layer 130 on the top of the micro-structures 140 is melted by heating. Then, the melted thermoplastic polymer layer 130 on the top of the micro-structures 140 is solidified by cooling.

The machined thermoplastic polymer layer 130 on the top of the micro-structures 140 is melted by heating the machined thermoplastic polymer layer 130 to a desired temperature according to the material of the machined thermoplastic polymer layer 130. Basically, the desired temperature is higher than the melting point of the machined thermoplastic polymer layer 130. For example, the machined thermoplastic polymer layer 130 is heated to a temperature of about 150° C. to melt it when the material of the machined thermoplastic polymer layer 130 is a positive photoresist.

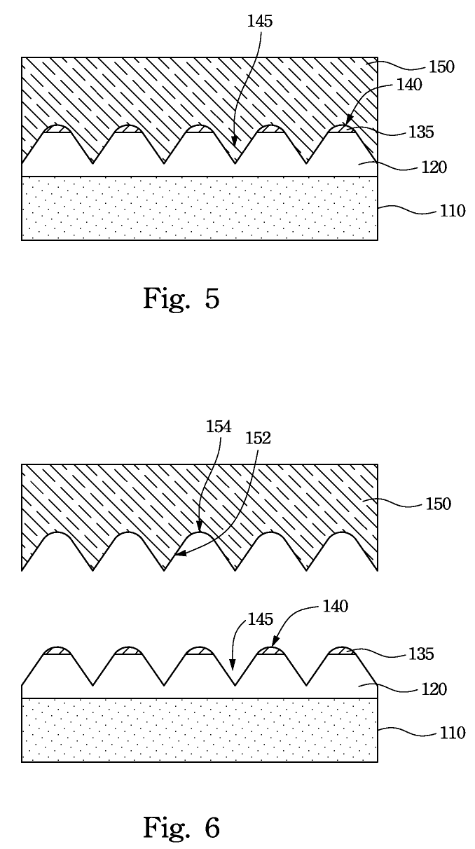

According to another embodiment of the present invention, a mold manufactured by the above method is provided. FIG. 7 is a three-dimensional view of the mold of FIG. 4. The mold includes a substrate 110 and a plurality of micro-structures 140. The micro-structures 140 are disposed on the substrate 110. Each of the micro-structures 140 includes a supporting layer 120 and a convex top portion 135. The supporting layer 120 is disposed on the substrate 110, wherein the material of the supporting layer 120 is amorphous metal. The convex top portion 135 is disposed on the supporting layer 120, wherein the material of the convex top portion 135 is a thermoplastic polymer.

The mold of FIG. 4 and/or FIG. 7 is used to electroform a metal die, such as a nickel die, a copper die, a chromium die, or a titanium die. Specifically, the die 150 is formed on the substrate 110 after the machined thermoplastic polymer layer 130 is reflowed, as shown in FIG. 5. This step is performed by electroforming. For example, if the manufacturers want to electroform a nickel die, a seeding layer (not shown) having a thickness of about 100-5000 Å is formed on the substrate 110 first, and then the nickel die is electroformed onto the substrate 110 through a nickel aminosulfonate bath. The thickness of the nickel die is about 0.05-10 mm.

Reference is made to FIG. 6. The die 150 and the substrate 110 is separated, and then the die 150 is used in injection molding, hot pressing, or ultraviolet curing to manufacture optical elements. As shown in FIG. 6, the die 150 has a plurality of prism features 152 formed by the machining step and a plurality of convex features 154 formed by the reflowing step. Accordingly, optical elements manufactured by the die 150 have a light concentrating capability of the prism features 152 and a light diffusing capability of the convex features 154. Furthermore, the convex features 154 can prevent the optical elements from scraping other elements.

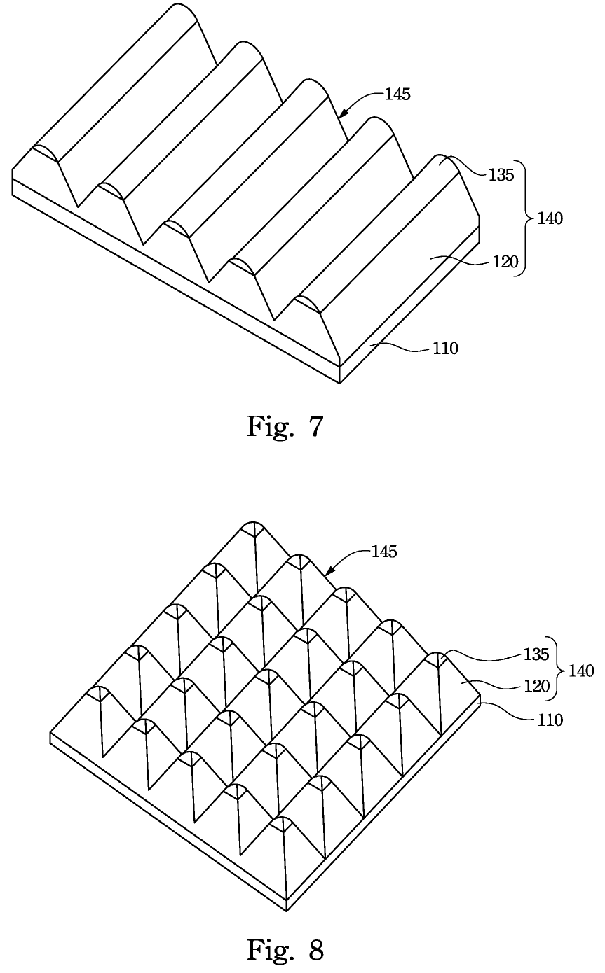

It is appreciated that FIGS. 1-7 only depict some embodiments of the present invention, and some specific details may be adapted to satisfy different requirements. For example, although FIG. 7 depicts each micro-structure 140 as a prism, i.e. a solid object with matching ends and several sides which are the same width all the way up, it is appreciated that each micro-structure 140 may be a pyramid as well (as shown in FIG. 8).

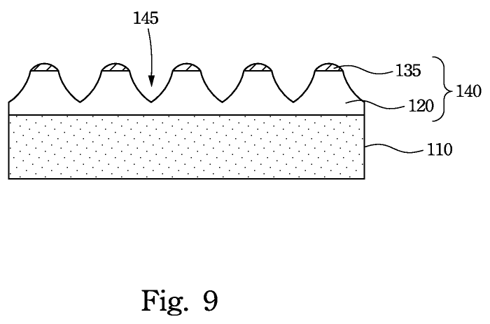

Similarly, although FIG. 4 depicts each groove 145 as a V-cut, the section of each groove 145 may be a spherical segment as well (as shown in FIG. 9) if the manufacturers make some changes to the machining step. In other words, although FIG. 4 depicts that a side surface of the supporting layer 120 includes a plane surface, a side surface of the supporting layer 120 may include a curved surface as well (as shown in FIG. 9). Basically, a curvature of the side surface of the supporting layer 120 is different from a curvature of a surface of the convex top portion 135.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A mold comprising:
a substrate; and
a plurality of micro-structures disposed on the substrate, each of the micro-structures comprising:
a supporting layer disposed on the substrate, wherein the material of the supporting layer is amorphous metal; and
a convex top portion disposed on the supporting layer, wherein the material of the convex top portion is a thermoplastic polymer.

2. The mold of claim 1, wherein the material of the convex top portion is a positive photoresist.

3. The mold of claim 1, wherein the material of the convex top portion is polymethylmethacrylate (PMMA).

4. The mold of claim 1, wherein a side surface of the supporting layer comprises a plane surface.

5. The mold of claim 1, wherein a side surface of the supporting layer comprises a curved surface.

6. The mold of claim 5, wherein a curvature of the side surface of the supporting layer is different from a curvature of a surface of the convex top portion.
